(19) United States
(12) Patent Application Publication
(10) Pub. No.: US 2023/0401355 A1
(43) Pub. Date: Dec. 14, 2023

(54) METHOD AND SYSTEM FOR VALIDATING PRODUCT AND MANUFACTURING INFORMATION OF A GEOMETRIC MODEL

(71) Applicant: Siemens Industry Software Inc., Plano, TX (US)

(72) Inventors: Janardan Gaikwad, Pune, Maharashtra (IN); Dinesh Patange, Pune, Maharashtra (IN)

(21) Appl. No.: 18/035,175

(22) PCT Filed: Jun. 30, 2021
(86) PCT No.: PCT/US2021/039797

§ 371 Date: May 3, 2023

(30) Foreign Application Priority Data
Nov. 3, 2020 (IN) 202031047976

(51) Int. Cl. G06F 30/20; G06F 30/12

(52) U.S. Cl. CPC G06F 30/20; G06F 30/12; G06F 2119/18

(57) ABSTRACT

A method and a system for validating product and manufacturing information associated with a geometric model in a computer-aided design environment are provided. The method includes generating a geometric model of a physical object in the computer-aided design environment. The geometric model of the physical object includes product and manufacturing information. The method includes extracting the product and manufacturing information from the geometric model, and validating the extracted product and manufacturing information using at least one checker. The at least one checker includes one or more logical elements capable of validating the product and manufacturing information. The method includes outputting results of the validating of the product and manufacturing information on a graphical user interface.

### PRIORITY

This application is the National Stage of International Application No. PCT/US2021/039797, filed Jun. 30, 2021, which claims the benefit of Indian Patent Application No. IN 202031047976, filed Nov. 3, 2020. The entire contents of these documents are hereby incorporated herein by reference.

### FIELD OF TECHNOLOGY

The present disclosure generally relates to the field of computer-aided design (CAD), and more particularly to a method and system for validating product and manufacturing information of a geometric model in a computer-aided design environment.

### BACKGROUND

Computer-aided design tools enable users to design physical objects in the form of geometric models. The geometric models contain product and manufacturing information (also known as geometric dimensioning and tolerancing) that indicates non-geometric attributes necessary for manufacturing and assembly of physical objects. For example, product and manufacturing information associated with a hole may include positional tolerance for a hole with respect to datums (e.g., reference features/geometries) A, B and C should be 0.01.

It is important that product and manufacturing information associated with a geometric model of a physical object meets standard compliant criteria prior to manufacturing of the physical object. This provides that the product and manufacturing information carries appropriate design intent for manufacturing and/or inspection. To meet this requirement, the product and manufacturing information is validated using manual techniques or out of box checkers. Manual validation of the product and manufacturing information is tedious and error-prone process. However, out of box checkers are based on fixed logic. With new standards being evolving frequently, the out of box checkers may not comply with these standards and contextual variations and interpretation of standards. Since, the out of box checkers are based on fixed logic, validators cannot make any changes to these out of box checkers based on the evolving standards and contextual variations of the standards, leading to incomplete and erroneous validation of the product and manufacturing information. In order to fully validate the product and manufacturing information with respect to the standards, the validators may have to use manual techniques in absence of adequate checkers for validating product and manufacturing information. This may be a tedious and error-prone activity.

### SUMMARY AND DESCRIPTION

A method and system for validating product and manufacturing information of a geometric model in computer-aided design (CAD) environment is disclosed. In one aspect, a method includes generating a geometric model of a physical object in the computer-aided design environment. The geometric model of the physical object includes product and manufacturing information associated with the physical object. The method may include extracting the product and manufacturing information from the geometric model. Also, the method includes validating the extracted product and manufacturing information using one or more checkers. The one or more checkers include one or more logical elements capable of validating the product and manufacturing information. The method includes outputting results of the validating of the product and manufacturing information on a graphical user interface.

The method may include identifying the one or more checkers for validating the product and manufacturing information associated with the geometric model from a plurality of checkers in a checker database based on a type of the product and manufacturing information. In the act of identifying the one or more checkers for validating the product and manufacturing information, the method may include determining whether there is at least one checker suitable for validating the product and manufacturing information in the checker database. If there is at least one checker available in the checker database, the method may include obtaining the at least one checker for validating the product and manufacturing information from the checker database.

If there is no checker available in the checker database, the method may include determining whether there is at least one checker in the checker database that may be modified. If there is at least one checker that may be modified, the method may include modifying the logical elements of the at least one checker such that the modified at least one checker is capable of validating the product and manufacturing information.

In the act of modifying the logical elements of the at least one checker, the method may include determining at least one standard associated with validation of the product and manufacturing information based on the type of the product and manufacturing information. Then, the method may include generating at least one standard compliant criterion for validating the product and manufacturing information. The method may include identifying one or more logical elements from a plurality of logical elements based on the at least one standard compliant criterion. Also, the method may include determining one or more logical elements that need to be substituted in the at least one checker based on the at least one standard compliant criterion. The method may include modifying the at least one checker by replacing the identified one or more logical elements with the one or more logical elements that need to be substituted.

Alternatively, if there is no checker in the checker database that may be modified, the method may include generating a new checker for validating the product and manufacturing information associated with the geometric model of the physical object.

In the act of generating the new checker for validating the product and manufacturing information associated with the geometric model, the method may include determining at least one standard associated with validation of the product and manufacturing information based on the type of the product and manufacturing information. The method may include generating at least one standard compliant criterion for validating the product and manufacturing information. Also, the method may include identifying one or more logical elements from a plurality of logical elements based on the at least one standard compliant criterion. The method may include generating the checker for validating the product and manufacturing information using the one or more logical elements.

In the act of validating the extracted product and manufacturing information using the at least one checker, the method may include comparing the product and manufacturing information with standard compliant criterion using the logical elements in the at least one checker. The method may include determining whether the product and manufacturing information matches the standard compliant criterion. If the product and manufacturing information matches the standard compliant criterion, the method may include generating a signal indicating that the product and manufacturing information is successfully validated. If the product and manufacturing information does not match the standard compliant criterion, the method may include generating a signal indicating failure to validate the product and manufacturing information.

In another aspect, a data processing system includes one or more processing units and a memory unit communicatively coupled to the one or more processing units. The memory unit includes a product manufacturing information (PMI) validation module stored in the form of machine-readable instructions and executable by the one or more processing units. The PMI validation module is configured to generate a geometric model of a physical object in the computer-aided design environment. The geometric model of the physical object includes product and manufacturing information associated with the physical object. The PMI validation module is configured to extract the product and manufacturing information from the geometric model. Also, the PMI validation module is configured to validate the extracted product and manufacturing information using one or more checkers. The one or more checkers include one or more logical elements capable of validating the product and manufacturing information. The PMI validation module is also configured to output results of validation of the product and manufacturing information on a graphical user interface.

The PMI validation module is configured to identify the one or more checkers for validating the product and manufacturing information associated with the geometric model from a plurality of checkers in a checker database based on a type of the product and manufacturing information.

In the act of identifying the one or more checkers for validating the product and manufacturing information, the PMI validation module is configured to determine whether there is at least one checker suitable for validating the product and manufacturing information in the checker database. If there is at least one checker available in the checker database, the PMI validation module is configured to obtain the at least one checker for validating the product and manufacturing information from the checker database.

If there is no checker available in the checker database, the PMI validation module is configured to determine whether there is at least one checker in the checker database that may be modified. If there is at least one checker that may be modified, the PMI validation module is configured to modify the logical elements of the at least one checker such that the modified checker is capable of validating the product and manufacturing information.

In the act of modifying the logical elements of the at least one checker, the PMI validation module is configured to determine at least one standard associated with validation of the product and manufacturing information based on type of the product and manufacturing information. Then, the PMI validation module is configured to generate at least one standard compliant criterion for validating the product and manufacturing information. The PMI validation module is configured to identify one or more logical elements from a plurality of logical elements based on the at least one standard compliant criterion. Also, the PMI validation module is configured to determine one or more logical elements that need to be substituted in the at least one checker based on the at least one standard compliant criterion. The PMI validation module is also configured to modify the at least one checker by replacing the identified logical elements with the logical elements that need to be substituted.

Alternatively, if there is no checker in the checker database that may be modified, the PMI validation module is configured to generate a new checker for validating the product and manufacturing information associated with the geometric model of the physical object.

In the act of generating the new checker for validating the product and manufacturing information associated with the geometric model, the PMI validation module is configured to determine at least one standard associated with validation of the product and manufacturing information based on the type of the product and manufacturing information. The PMI validation module is configured to generate at least one standard compliant criterion for validating the product and manufacturing information. Also, the PMI validation module is configured to identify one or more logical elements from a plurality of logical elements based on the at least one standard compliant criterion. The PMI validation module is also configured to generate the checker for validating the product and manufacturing information using the one or more logical elements.

In the act of validating the extracted product and manufacturing information using the at least one checker, the PMI validation module is configured to compare the product and manufacturing information with standard compliant criterion using the logical elements in the at least one checker. The PMI validation module is configured to determine whether the product and manufacturing information matches the standard compliant criterion. If the product and manufacturing information matches the standard compliant criterion, the PMI validation module is configured to generate a signal indicating that the product and manufacturing information is successfully validated. If the product and manufacturing information does not match the standard compliant criterion, the PMI validation module is configured to generate a signal indicating failure to validate the product and manufacturing information.

In yet another aspect, a non-transitory computer-readable storage medium that stores machine-readable instructions executable by a data processing system to perform method acts described above is provided.

This summary is provided to introduce a selection of concepts in a simplified form that are further described below in the following description. The summary is not intended to identify features or essential features of the claimed subject matter. Further, the claimed subject matter is not limited to implementations that solve any or all disadvantages noted in any part of this disclosure.

### BRIEF DESCRIPTION OF DRAWINGS

FIG. 1 is a block diagram of a data processing system for validating product and manufacturing information of a geometric model in a computer-aided design (CAD) environment, according to one embodiment.

FIG. 2 illustrates a process flowchart of a method of validating product and manufacturing information of a geometric model in the CAD environment, according to one embodiment.

FIG. 3 illustrates a process flowchart of a method of validating product and manufacturing information of a geometric model in a CAD environment, according to another embodiment.

FIG. 4 illustrates a block diagram of a data processing system for validating product and manufacturing information of a geometric model in a CAD environment, according to another embodiment.

FIG. 5 illustrates a block diagram of a data processing system for validating product and manufacturing information of a geometric model in a CAD environment, according to yet another embodiment.

### DETAILED DESCRIPTION

A method and a system for validating product and manufacturing information of a geometric model in a computer-aided design (CAD) environment is disclosed. Various embodiments are described with reference to the drawings, where like reference numerals are used in reference to the drawings. Like reference numerals are used to refer to like elements throughout. In the following description, numerous specific details are set forth in order to provide a thorough understanding of embodiments. These specific details need not be employed to practice embodiments. In other instances, well known materials or methods have not been described in detail in order to avoid unnecessarily obscuring embodiments. While the disclosure is susceptible to various modifications and alternative forms, specific embodiments thereof are shown by way of example in the drawings and will herein be described in detail. There is no intent to limit the disclosure to the particular forms disclosed. Instead, the disclosure is to cover all modifications, equivalents, and alternatives falling within the spirit and scope of the present disclosure.

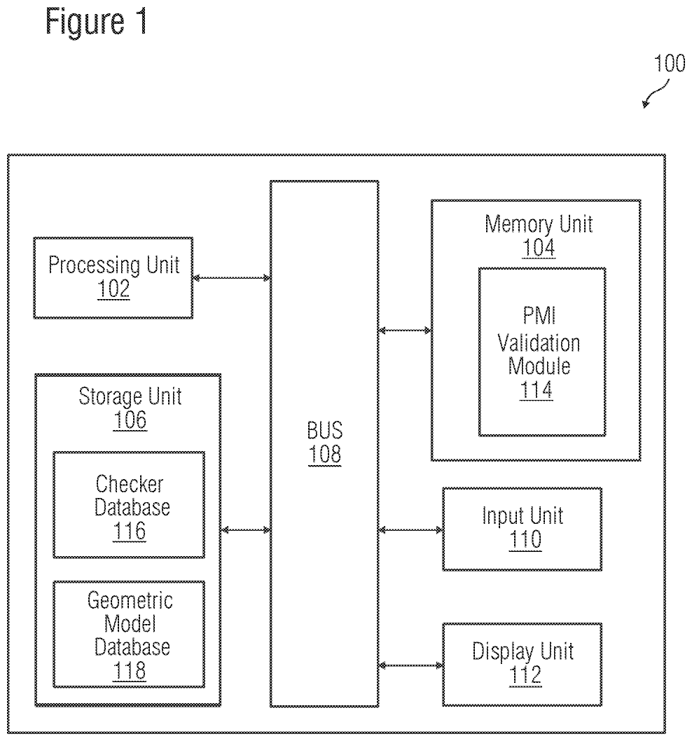

FIG. 1 is a block diagram of an exemplary data processing system 100 for validating product and manufacturing information of a geometric model in a computer-aided design (CAD) environment, according to one embodiment. The data processing system 100 may be a personal computer, a workstation, a laptop computer, a tablet, and the like. In FIG. 1, the data processing system 100 includes processing unit(s) 102, a memory 104, a storage unit 106, a bus 108, an input unit 110, and a display unit 112. The data processing system 100 is a specific purpose computer configured to validate product and manufacturing information of a geometric model of a physical object.

The processing unit(s) 102, as used herein, may be any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit(s) 102 may also include embedded controllers, such as generic or programmable logic devices or arrays, application specific integrated circuits, single-chip computers, and the like.

The memory unit 104 may be non-transitory volatile memory and non-volatile memory. The memory unit 104 may be coupled for communication with the processing unit(s) 102, such as being a computer-readable storage medium. The processing unit(s) 102 may execute instructions and/or code stored in the memory unit 104. A variety of computer-readable instructions may be stored in and accessed from the memory unit 104. The memory unit 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

In the present embodiment, the memory unit 104 includes a product and manufacturing information (PMI) validation module 114 stored in the form of machine-readable instructions on any of the above-mentioned storage media and may be in communication with and executed by the processing unit(s) 102. When the machine-readable instructions are executed by the processing unit(s) 102, the PMI validation module 114 causes the processing unit(s) 102 to generate a geometric model of a physical object in a computer-aided design (CAD) environment. The geometric model of the physical object includes product and manufacturing information (PMI). The PMI validation module 114 causes the processing unit(s) 102 to extract the product and manufacturing information from the geometric model.

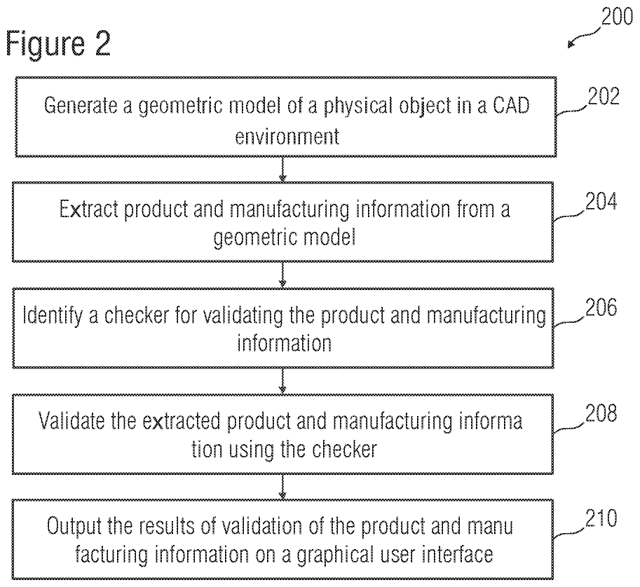

The PMI validation module 114 cause the processing unit(s) 102 to identify a suitable checker from the checker database 116 based on type of product and manufacturing information associated with the geometric model. If no suitable checker is found, the PMI validation module 114 causes the processing unit(s) 102 to modify the existing checkers by adding/deleting/substituting one or more logical elements based on standard compliant criteria. In case, the checker is not available, the PMI validation module 114 causes the processing unit(s) 102 to generate a new checker with one or more logical elements based on a standard compliant criterion. The PMI validation module 114 causes the processing unit(s) 102 to validate the extracted product and manufacturing information using one or more checkers. The checker includes one or more logical elements capable of validating the product and manufacturing information. The PMI validation module 114 causes the processing unit(s) 102 to output results of the validation of the product and manufacturing information on the display unit 112. Additionally, the PMI validation module 114 causes the processing unit(s) 102 to publish the geometric model having product and manufacturing information that is successfully validated and make the geometric model available for downstream consumption. Method acts performed by the processing unit(s) 102 to achieve the above functionality are described in greater detail in FIG. 2.

The storage unit 106 may be a non-transitory storage medium that stores a checker database 116 and a geometric model database 118. The checker database 116 stores checkers for validating product and manufacturing information. The checker database 116 may also store a plurality of logical elements for creating or modifying checkers. Additionally, the geometric model database 118 stores geometric models along with product and manufacturing information. The input unit 110 may include input devices such as keypad, touch-sensitive display, camera (e.g., a camera receiving gesture-based inputs), etc. capable of receiving input signals such as a PMI validation command for performing a validation of product and manufacturing information associated with the geometric model. The display unit 112 may be a device with a graphical user interface displaying results of validation of the product and manufacturing information in conjunction with the geometric model. The graphical user interface may also enable users to select PMI validation command for performing the validation of product and manufacturing information. The bus 108 acts as interconnect between the processing unit(s) 102, the memory unit 104, the storage unit 106, the input unit 110, and the display unit 112.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition to or in place of the hardware depicted. The depicted example is provided for the purpose of explanation only and is not meant to imply architectural limitations with respect to the present disclosure.

The data processing system 100 in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed, and/or an event such as clicking a mouse button may be generated to actuate a desired response.

One of various commercial operating systems, such as a version of Microsoft Windows™, a product of Microsoft Corporation located in Redmond, Washington may be employed if suitably modified. The operating system is modified or created in accordance with the present disclosure as described.

FIG. 2 illustrates a process flowchart 200 of an exemplary method of validating product and manufacturing information of a geometric model in a computer-aided design (CAD) environment, according to one embodiment. At act 202, a geometric model of a physical object is generated in the CAD environment. The geometric model of the physical object includes product and manufacturing information. At act 204, the product and manufacturing information is extracted from the geometric model.

At act 206, a checker for validating the product and manufacturing information is identified from a plurality of checkers in a checker database based on type of the product and manufacturing information. At act 208, the extracted product and manufacturing information is validated using the checker. The checker includes one or more logical elements capable of validating the product and manufacturing information. In some embodiments, the product and manufacturing information is compared with standard compliant criterion using the logical elements in the checker. Then, it is determined whether the product and manufacturing information matches the standard compliant criterion. If the product and manufacturing information matches the standard compliant criterion, a signal indicating that successful validation of the product and manufacturing information is generated. Alternatively, a signal indicating failure to validate the product and manufacturing information is generated if the product and manufacturing information does not match the standard compliant criterion. At act 210, the results of validation of the product and manufacturing information is output on a graphical user interface.

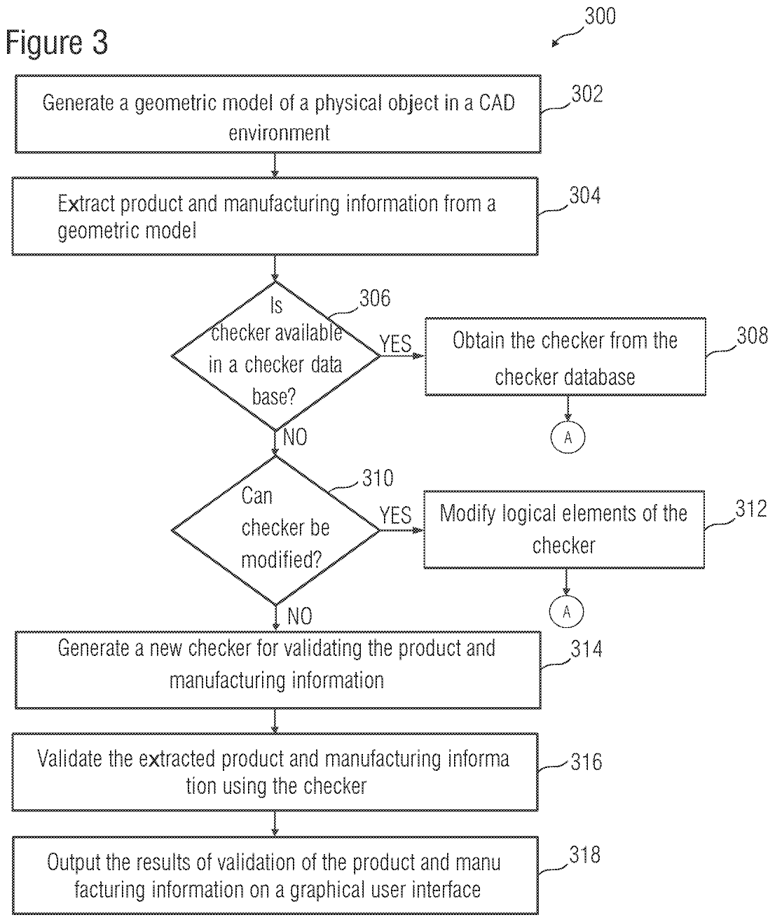

FIG. 3 illustrates a process flowchart 300 of an exemplary method of validating product and manufacturing information of a geometric model in a CAD environment, according to another embodiment. At act 302, a geometric model of a physical object is generated in the CAD environment. The geometric model of the physical object includes product and manufacturing information. At act 304, the product and manufacturing information is extracted from the geometric model.

At act 306, it is determined whether there is at least one checker suitable for validating the product and manufacturing information in a checker database. If there is at least one checker available in the checker database, at act 308, the at least one checker for validating the product and manufacturing information is obtained from the checker database. If there is no checker available in the checker database, then at act 310, it is determined whether there is at least one checker in the checker database that may be modified.

If there is at least one checker that may be modified, then at act 312, logical elements of the at least one checker are modified such that the modified checker is capable of validating the product and manufacturing information. In some embodiments, at least one standard associated with validation of the product and manufacturing information is determined based on a type of the product and manufacturing information. Then, at least one standard compliant criterion for validating the product and manufacturing information is generated. One or more logical elements are identified from a plurality of logical elements based on the standard compliant criteria. Also, one or more logical elements that need to be substituted in the at least one checker are identified based on the standard compliant criteria. Accordingly, the at least one checker is modified by replacing the identified logical elements with the logical elements to be substituted.

If there is no checker in the checker database, then at act 314, a new checker for validating the product and manufacturing information associated with the geometric model of the physical object is generated. In some embodiments, at least one standard associated with validation of the product and manufacturing information is determined based on the type of the product and manufacturing information. Then, at least one standard compliant criterion for validating the product and manufacturing information is generated. Accordingly, one or more logical elements are identified from a plurality of logical elements based on the standard compliant criteria. The new checker for validating the product and manufacturing information is generated using the one or more logical elements. The new checker is stored in the checker database 116.

At act 316, the extracted product and manufacturing information is validated using the checker. The checker includes one or more logical elements capable of validating the product and manufacturing information. In some embodiments, the product and manufacturing information is compared with standard compliant criterion using the logical elements in the checker. Then, it is determined whether the product and manufacturing information matches the standard compliant criterion. If the product and manufacturing information matches the standard compliant criterion, a signal indicating that successful validation of the product and manufacturing information is generated. Alternatively, a signal indicating failure to validate the product and manufacturing information is generated if the product and manufacturing information does not match the standard compliant criterion. At act 318, the results of validation of the product and manufacturing information is outputted on a graphical user interface.

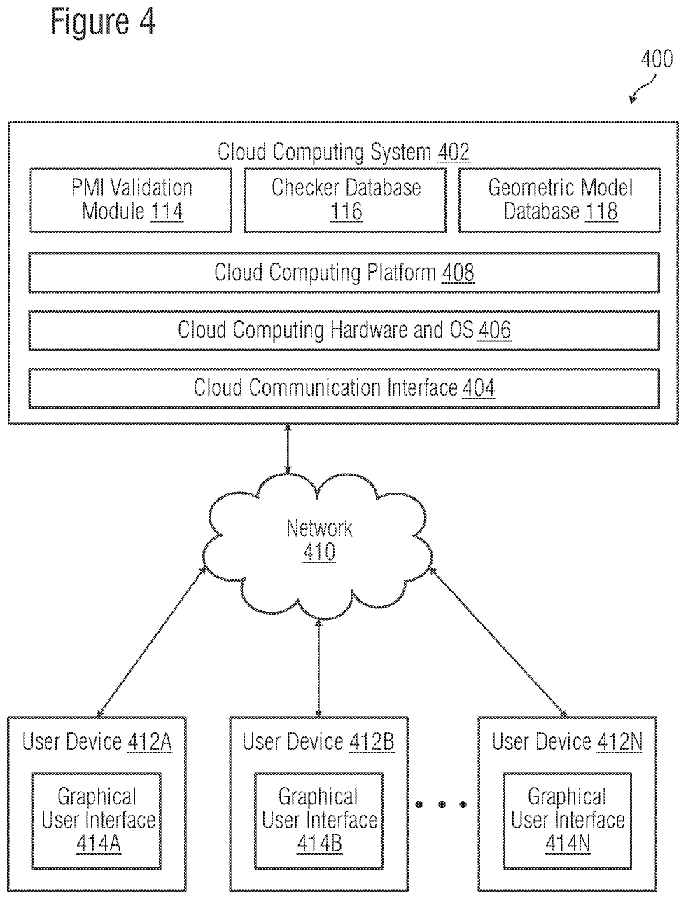

FIG. 4 is a schematic representation of a data processing system 400 for validating product and manufacturing information associated with a geometric model in a computer-aided design environment, according to another embodiment. In one embodiment, the data processing system 400 includes a cloud computing system 402 configured for providing cloud services for designing geometric components (also referred to as physical objects) including generating geometric models of geometric components and validating product and manufacturing information associated with the geometric components. The geometric component may be single component (e.g., shaft) or an assembly of a number of parts (e.g., car).

The cloud computing system 402 includes a cloud communication interface 406, cloud computing hardware and OS 408, a cloud computing platform 410, the PMI validation module 114, the checker database 116, and the geometric model database 118. The cloud communication interface 406 enables communication between the cloud computing platform 410 and user devices 412A-N such as a smart phone, a tablet, a computer, etc. via a network 404.

The cloud computing hardware and OS 408 may include one or more servers on which an operating system (OS) is installed and includes one or more processing units, one or more storage devices for storing data, and other peripherals required for providing cloud computing functionality. The cloud computing platform 410 is a platform that implements functionalities such as data storage, data analysis, data visualization, data communication on the cloud hardware and OS 408 via Application Programming Interfaces (APIs) and algorithms, and delivers the aforementioned cloud services using cloud based applications (e.g., computer-aided design application).

The cloud computing platform 410 employs the PMI validation module 114 configured for generating a geometric model of a physical object in a CAD environment. The geometric model of the physical object includes product and manufacturing information. The PMI validation module 114 is configured for extracting the product and manufacturing information from the geometric model. The PMI validation module 114 is configured for identifying a suitable checker from the checker database 116 based on the type of product and manufacturing information associated with the geometric model. If no suitable checker is found, the PMI validation module 114 is configured for modifying the existing checkers by adding/deleting/substituting one or more logical elements based on standard compliant criteria. In case the checker is not available, the PMI validation module 114 is configured for generating a new checker with one or more logical elements based on a standard compliant criterion. The PMI validation module 114 is configured for validating the extracted product and manufacturing information using one or more checkers. The checker includes one or more logical elements capable of validating the product and manufacturing information. The PMI validation module 114 is configured for outputting results of validation of the product and manufacturing information on the display unit 112. Additionally, the PMI validation module 114 is configured for publishing the geometric model having product and manufacturing information that is successfully validated and making the geometric model available for downstream consumption.

The cloud computing platform 410 includes the checker database 116 for storing checkers for validating product and manufacturing information and logical elements for generating or modifying checkers. The cloud computing platform 410 also includes the geometric model database 118 for storing geometric models and/or computer-aided design files. The cloud computing platform 410 may include a combination of dedicated hardware and software built on top of the cloud hardware and OS 408.

In accordance with the foregoing embodiments, the cloud computing system 402 may enable users to validate product and manufacturing information associated with a geometric model in a CAD environment.

The user devices 412A-N include graphical user interfaces 414A-N for receiving a selection of CAD commands and displaying CAD environment with geometric models with product and manufacturing information. Each of the user devices 412A-N may be provided with a communication interface for interfacing with the cloud computing system 402. Users of the user devices 412A-N may access the cloud computing system 402 via the graphical user interfaces 414A-N. For example, the users may send a request to the cloud computing system 402 to validate product and manufacturing information associated with a geometric model. The graphical user interfaces 414A-N may be specifically configured for accessing the PMI validation module 114 in the cloud computing system 402.

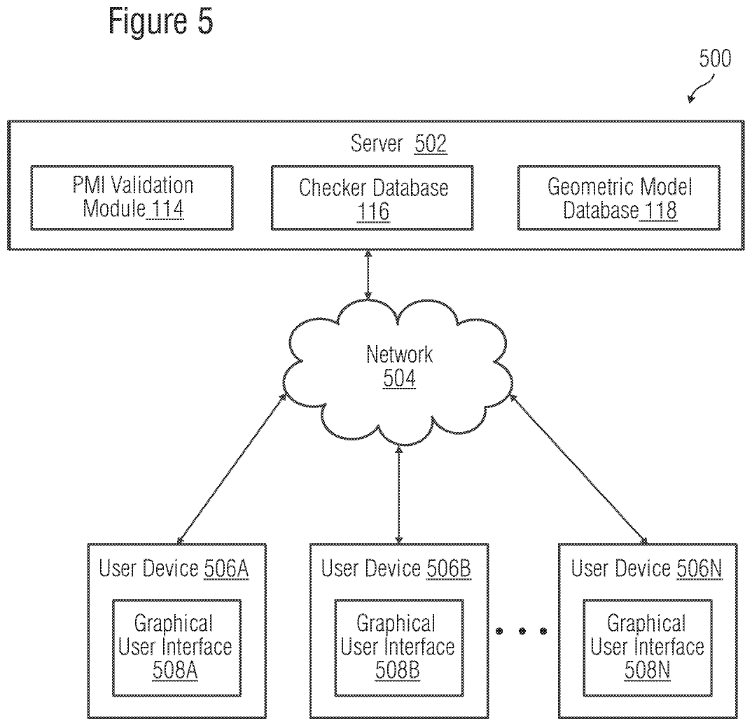

FIG. 5 illustrates a block diagram of a data processing system 500 for validating product and manufacturing information of a geometric model in a CAD environment, according to yet another embodiment. For example, the data processing system 500 includes a server 502 and a plurality of user devices 506A-N. Each user device of the plurality of user devices 506A-N is connected to the server 502 via a network 504 (e.g., Local Area Network (LAN), Wide Area Network (WAN), Wi-Fi, etc.). The data processing system 500 is another implementation of the data processing system 100 of FIG. 1, where the PMI validation module 114 resides in the server 502 and is accessed by user devices 506A-N via the network 504.

The server 502 includes the PMI validation module 114, the checker database 116, and the geometric model database 118. The server 502 may also include a processor, a memory, and a storage unit. The PMI validation module 114 may be stored on the memory in the form of machine-readable instructions and executable by the processor. The checker database 116, and the geometric model database 118 may be stored in the storage unit. The server 502 may also include a communication interface for enabling communication with user devices 506A-N via the network 504.

When the machine-readable instructions are executed by the server 502, the PMI validation module 114 causes the server 502 to generate a geometric model of a physical object in a CAD environment. The geometric model of the physical object includes product and manufacturing information. The PMI validation module 114 causes the server 502 to extract the product and manufacturing information from the geometric model. The PMI validation module 114 causes the server 502 to identify a suitable checker from the checker database 116 based on the type of product and manufacturing information associated with the geometric model. If no suitable checker is found, the PMI validation module 114 causes the server 502 to modify the existing checkers by adding/deleting/substituting one or more logical elements based on standard compliant criteria. In case the checker is not available, the PMI validation module 114 causes the server 502 to generate a new checker with one or more logical elements based on a standard compliant criterion. The PMI validation module 114 causes the server 502 to validate the extracted product and manufacturing information using one or more checkers. The checker includes one or more logical elements capable of validating the product and manufacturing information. The PMI validation module 114 causes the server 502 to output the results of validation of the product and manufacturing information on the display unit 112. Additionally, the PMI validation module 114 causes the server 502 to publish the geometric model having product and manufacturing information that is successfully validated and makes the geometric model available for downstream consumption.

The plurality of user devices 506A-N include graphical user interfaces 508A-N for receiving a selection of CAD commands (e.g., PMI validation command) and displaying a CAD environment including geometric models. Each user device of the plurality of user devices 506A-N may be provided with a communication interface for interfacing with the server 502. Users of the plurality of user devices 506A-N may access the server 502 via the graphical user interfaces 508A-N. For example, the users may send a request to the server 502 to validate product and manufacturing information associated with a geometric model. The graphical user interfaces 508A-N may be specifically configured for accessing the PMI validation module 114 in the server 502.

Those skilled in the art will recognize that, unless specifically indicated or required by the sequence of operations, certain acts in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementation and practices known in the art.

The system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be an electronic, magnetic, optical, electromagnetic, infrared, or semiconductor system (or apparatus or device), or propagation mediums in and of themselves as signal carriers are not included in the definition of physical computer-readable medium, which includes a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and digital versatile disc (DVD). Both processors and program code for implementing each aspect of the technology may be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

1. A method of validating product and manufacturing information associated with a geometric model in a computer-aided design environment, the method comprising:
generating a geometric model of a physical object in the computer-aided design environment, wherein the geometric model of the physical object comprises product and manufacturing information;
extracting the product and manufacturing information from the geometric model;
validating the extracted product and manufacturing information using at least one checker, wherein the at least one checker comprises one or more logical elements capable of validating the product and manufacturing information; and
outputting results of the validation of the extracted product and manufacturing information on a graphical user interface.

2. The method of claim 1, further comprising:
identifying the at least one checker for validating the product and manufacturing information associated with the geometric model from a plurality of checkers in a checker database based on a type of the product and manufacturing information.

3. The method of claim 2, wherein identifying the at least one checker for validating the product and manufacturing information comprises:
determining whether there is at least one checker suitable for validating the product and manufacturing information in the checker database;
when, based on the determining, there is no checker in the checker database, determining whether there is at least one checker in the checker database that is modifiable; and
when there is at least one checker in the checker database, obtaining the at least one checker for validating the product and manufacturing information from the checker database.

4. The method of claim 3, wherein determining whether there is at least one checker in the checker database that is modifiable comprises:
when there is at least one checker that is modifiable, modifying the one or more logical elements of the at least one checker, such a that the modified checker is capable of validating the product and manufacturing information; and
when there is no checker in the checker database, generating a checker for validating the product and manufacturing information associated with the geometric model of the physical object.

5. The method of claim 4, wherein generating the checker for validating the product and manufacturing information associated with the geometric model comprises:
determining at least one standard associated with the validation of the product and manufacturing information based on the type of the product and manufacturing information;
generating at least one standard compliant criterion for validating the product and manufacturing information;
identifying the one or more logical elements from a plurality of logical elements based on the at least one standard compliant criterion; and
generating the at least one checker for validating the product and manufacturing information using the one or more logical elements.

6. The method of claim 4, wherein modifying the one or more logical elements of the at least one checker comprises:
determining at least one standard associated with the validation of the product and manufacturing information based on the type of the product and manufacturing information;
generating at least one standard compliant criterion for validating the product and manufacturing information;
identifying the one or more logical elements from a plurality of logical elements based on the at least one standard compliant criteria;
determining at least one logical element that needs to be substituted in the at least one checker based on the at least one standard compliant criterion; and
modifying the at least one checker, the modifying of the at least one checker comprising replacing the identified one or more logical elements with the at least one logical element that needs to be substituted.

7. The method of claim 1, wherein validating the extracted product and manufacturing information using the at least one checker comprises:
comparing the product and manufacturing information with standard compliant criterion using the one or more logical elements in the at least one checker;
determining whether the product and manufacturing information matches the standard compliant criterion;
when, based on the determining, the product and manufacturing information matches the standard compliant criterion, generating a signal indicating that the product and manufacturing information is successfully validated; and
when, based on the determining, the product and manufacturing information does not match the standard compliant criterion, generating a signal indicating failure to validate the product and manufacturing information.

8. A data processing system comprising:
one or more processing units; and
a memory unit communicatively coupled to the one or more processing units, wherein the memory unit comprises a PMI validation module configured to:
generate a geometric model of a physical object in a computer-aided design environment, wherein the geometric model of the physical object comprises product and manufacturing information;
extract the product and manufacturing information from the geometric model;
validate the extracted product and manufacturing information using at least one checker, wherein the at least one checker comprises one or more logical elements capable of validating the product and manufacturing information; and
output results of the validation of the product and manufacturing information on a graphical user interface.

9. The data processing system of claim 8, wherein the PMI validation module is further configured to:
identify the at least one checker for validating the product and manufacturing information associated with the geometric model from a plurality of checkers in a checker database based on a type of the product and manufacturing information.

10. The data processing system of claim 9, wherein the PMI validation module being configured to identify the at least one checker for validating the product and manufacturing information comprises the PMI validation module being configured to:
determine whether there is at least one checker suitable for validating the product and manufacturing information in the checker database;
when, based on the determination, there is no checker in the checker database, determine whether there is at least one checker in the checker database that is modifiable; and
when, based on the determination, there is at least one checker in the checker database, obtain the at least one checker for validating the product and manufacturing information from the checker database.

11. The data processing system of claim 10, wherein the PMI validation module being configured to determine whether there is at least one checker in the checker database that is modifiable comprises the PMI validation module being configured to:
modify the one or more logical elements of the at least one checker such that the at least one modified checker is capable of validating the product and manufacturing information when there is at least one checker that is modifiable; and
generate a checker for validating the product and manufacturing information associated with the geometric model of the physical object when there is no checker in the checker database.

12. The data processing system of claim 11, wherein the PMI validation module being configured to generate the checker for validating the product and manufacturing information associated with the geometric model comprises the PMI validation module being configured to:
determine at least one standard associated with validation of the product and manufacturing information based on the type of the product and manufacturing information;
generate at least one standard compliant criterion for validating the product and manufacturing information;
identify the one or more logical elements from a plurality of logical elements based on the at least one standard compliant criterion; and
generate the at least one checker for validating the product and manufacturing information using the one or more logical elements.

13. The data processing system of claim 11, wherein the PMI validation module being configured to modify the one or more logical elements of the at least one checker comprises the PMI validation module being configured to:
determine at least one standard associated with validation of the product and manufacturing information based on the type of the product and manufacturing information;
generate at least one standard compliant criterion for validating the product and manufacturing information;
identify the one or more logical elements from a plurality of logical elements based on the at least one standard compliant criterion;
determine at least one logical element that needs to be substituted in the at least one checker based on the at least one standard compliant criterion; and
modify the at least one checker, the modification of the at least one checker comprising replacement of the identified one or more logical elements with the at least one logical element that needs to be substituted.

14. The data processing system of claim 8, wherein the PMI validation module being configured to validate the extracted product and manufacturing information using the at least one checker comprises the PMI validation module being configured to:
compare the product and manufacturing information with standard compliant criterion using the one or more logical elements in the at least one checker;
determine whether the product and manufacturing information matches the standard compliant criterion;
when, based on the determination, the product and manufacturing information matches the standard compliant criterion, generate a signal indicating that the product and manufacturing information is successfully validated; and
when, based on the determination, the product and manufacturing information does not match the standard compliant criterion, generate a signal indicating failure to validate the product and manufacturing information.

15. A non-transitory computer-readable storage medium that stores machine-readable instructions executable by a data processing system to validating product and manufacturing information associated with a geometric model in a computer-aided design environment, the machine-readable instructions comprising:
generating a geometric model of a physical object in the computer-aided design environment, wherein the geometric model of the physical object comprises product and manufacturing information;
extracting the product and manufacturing information from the geometric model;
validating the extracted product and manufacturing information using at least one checker, wherein the at least one checker comprises one or more logical elements capable of validating the product and manufacturing information; and
outputting results of the validating of the product and manufacturing information on a graphical user interface.

16. The non-transitory computer-readable storage medium of claim 15, wherein the machine-readable instructions further comprise:
identifying the at least one checker for validating the product and manufacturing information associated with the geometric model from a plurality of checkers in a checker database based on a type of the product and manufacturing information.

17. The non-transitory computer-readable storage medium of claim 16, wherein identifying the at least one checker for validating the product and manufacturing information comprises:
determining whether there is at least one checker suitable for validating the product and manufacturing information in the checker database;
when, based on the determining, there is no checker in the checker database, determining whether there is at least one checker in the checker database that is modifiable; and
when, based on the determining, there is at least one checker in the checker database, obtaining the at least one checker for validating the product and manufacturing information from the checker database.

18. The non-transitory computer-readable storage medium of claim 17, wherein determining whether there is at least one checker in the checker database that is modifiable comprises:
modifying the one or more logical elements of the at least one checker such that the modified checker is capable of validating the product and manufacturing information when there is at least one checker that is modifiable; and
generating a checker for validating the product and manufacturing information associated with the geometric model of the physical object when there is no checker in the checker database.

19. The non-transitory computer-readable storage medium of claim 18, wherein generating the checker for validating the product and manufacturing information associated with the geometric model comprises:
determining at least one standard associated with validation of the product and manufacturing information based on the type of the product and manufacturing information;
generating at least one standard compliant criterion for validating the product and manufacturing information;
identifying the one or more logical elements from a plurality of logical elements based on the at least one standard compliant criterion; and
generating the checker for validating the product and manufacturing information using the one or more logical elements.

20. The non-transitory computer-readable storage medium of claim 18, wherein modifying the one or more logical elements of the at least one checker, comprises:
determining at least one standard associated with validation of the product and manufacturing information based on the type of the product and manufacturing information;
generating at least one standard compliant criterion for validating the product and manufacturing information;
identifying the one or more logical elements from a plurality of logical elements based on the at least one standard compliant criterion;
determining at least one logical element that needs to be substituted in the at least one checker based on the at least one standard compliant criterion; and
modifying the at least one checker, the modifying of the at least one checker comprising replacing the identified one or more logical elements with the at least one logical element that needs to be substituted.

21. The non-transitory computer-readable storage medium of claim 15, wherein validating the extracted product and manufacturing information using the at least one checker comprises:
comparing the product and manufacturing information with standard compliant criterion using the one or more logical elements in the at least one checker;
determining whether the product and manufacturing information matches the standard compliant criterion;
when, based on the determining, the product and manufacturing information matches the standard compliant criterion, generating a signal indicating that the product and manufacturing information is successfully validated; and
when, based on the determining, the product and manufacturing information does not match the standard compliant criterion, generating a signal indicating failure to validate the product and manufacturing information.
